(19) United States
(12) Patent Application Publication
(10) Pub. No.: US 2008/0094398 A1
(43) Pub. Date: Apr. 24, 2008

(54) Methods and systems for interacting with a 3D visualization system using a 2D interface ("DextroLap")

(75) Inventors: Hern NG, Singapore (SG); Luis SERRA, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a., Milano (IT)

(21) Appl. No.: 11/903,201

(22) Filed: Sep. 19, 2007

Related U.S. Application Data
(60) Provisional application No. 60/845,654, filed on Sep. 19, 2006.

(51) Int. Cl. G06T 15/20

(52) U.S. Cl. 345/427

(57) ABSTRACT

In exemplary embodiments of the present invention a 3D visualization system can be ported to a laptop or desktop PC, or other standard 2D computing environment, which uses a mouse and keyboard as user interfaces. Using the methods of exemplary embodiments of the present invention, a cursor or icon can be drawn at a contextually appropriate depth, thus preserving 3D interactivity and visualization while only having available 2D control. In exemplary embodiments of the present invention, a spatially correct depth can be automatically found for, and assigned to, the various cursors and icons associated with various 3D tools, control panels and other manipulations. In exemplary embodiments of the present invention this can preserve the three-dimensional experience of interacting with a 3D data set even though the 2D interface used to select objects and manipulate them cannot directly provide a third dimensional co-ordinate. In exemplary embodiments of the present invention, based upon the assigned position of the cursor or icon in 3D, the functionality of a selected tool, and whether and in what sequence any buttons have been pressed on a 2D interface device, a variety of 3D virtual tools and functionalities can be implemented and controlled by a standard 2D computer interface.

### CROSS-REFERENCE TO OTHER APPLICATIONS

This application claims the benefit of and incorporates by reference U.S. Provisional Patent Application No. 60/845,654, entitled “METHODS AND SYSTEMS FOR INTERACTING WITH A 3D VISUALIZATION SYSTEM USING A 2D INTERFACE (“DextroLap”),” filed on Sep. 19, 2006.

### TECHNICAL FIELD

The present invention relates to interactive visualization of three-dimensional data sets, and more particularly to enabling the functionality of 3D interactive visualization systems on a 2D data processing system, such as a standard PC or laptop.

### BACKGROUND OF THE INVENTION

Interactive 3D visualization systems (hereinafter sometimes referred to as “3D visualization systems”), allow a user to view and interact with one or more 3D datasets. An example of such a 3D visualization system, for example, is the Dextroscope™ running associated RadioDexter™ software, both provided by Volume Interactions Pte Ltd of Singapore. It is noted that 3D visualization systems often render 3D data sets stereoscopically. Thus, they render two images for each frame, one for each eye. This provides a user with stereoscopic depth cues and thus enhances the viewing experience. A 3D dataset generally contains virtual objects, such as, for example, three dimensional volumetric objects. These objects can be obtained, for example, from imaging scans of a subject using modalities such as MR, CT, ultrasound or the like. In general, a user of a 3D visualization system is primarily concerned with examining and manipulating volumetric objects using virtual tools. These virtual tools can include, for example, a virtual drill to remove a portion of an object, picking tools to select an object from a set of objects, manipulation tools to rotate, translate or zoom a 3D object, cropping tools to specify portions of an object, and measurement tools such as a ruler tool to measure distances, either absolute linear Cartesian distances or distances along a surface or section of one of the virtual objects.

Because a 3D visualization system presents a 3D environment, it is convenient to interact with such a visualization system using 3D interfaces, such as, for example, two 6D controllers, where, for example, one can be held in a user's left hand for translating and rotating virtual objects in 3D space, and the other can be held, for example, in a user's right hand to operate upon the virtual objects using various virtual tools. Using such controllers, for example, a user can move in three dimensions throughout the 3D environment.

Further, to streamline the use of such tools, a virtual control panel can be placed in the virtual world. Thus, for example, a user can select, via the virtual control panel, various objects and various tools to perform various manipulation, visualization and editing operations. Additionally, for example, a virtual control panel can be used to select various display modes for an object, such as, for example, full volume or tri-planar display. A virtual control panel can also be used, for example, to select a target object for segmentation, or to select two volumetric objects to be co-registered. A virtual control panel can be invoked by touching a surface with, for example, a right hand controller as described above.

Thus, although the “natural” interface to a 3D visualization system is the set of 3D control devices described above, sometimes it is desired to implement, to the extent possible, a 3D visualization system on a desktop or laptop PC, or other conventional data processing system having only 2D interface devices, such as a mouse and keyboard.

In such 2D implementations, control of virtual tools, and the positioning, rotation and manipulation of virtual objects in 3D space, needs to be mapped to the available mouse and keyboard. This can be difficult, inasmuch as while in 3D a user can move in three dimensions throughout the model space, when using a 2D interface, such as a mouse, for example, only motion in two dimensions can be performed. A mouse only moves in a plane, and provides no convenient manner to specify a z-value. Additionally, whereas when holding a 6D controller in his left hand a user can both translate and rotate a virtual object simultaneously, and such rotations can be about one, two or three axes, when mapping this functionality to a mouse and keyboard the rotation and translation operations must be separated, and any rotation can only be implemented along one axis at a time.

Besides issues concerning the control of 3D virtual tools, as noted above, using a mouse presents additional problems for 3D visualization systems. Problems arise if a cursor (or other icon) used to denote a 3D position within the model space is not given a z value. Cursors and icons of various types are used in 3D data sets to indicate a variety of things, such as, for example, the position of a picking tool, the center of zoom of a magnification tool, the drill bit of a drill tool, and the plane being moved using a cropping tool, to name just a few. Because a mouse has no z control, while a 3D cursor or icon being controlled by the movement of a 2D mouse needs to have a z value associated with it to properly function in a 3D model space, the 2D mouse simply has no means to provide any such z value. If the z value of the cursor is ignored, the cursor or icon will nearly always seem to appear at a different depth than the object it is pointing to.

These problems can be further exacerbated when the 3D visualization system uses a stereoscopic display.

When a virtual 3D world is to be displayed and viewed stereoscopically, two view ports are generally used; one view port to display what the left eye sees and the other view port to display what the right eye sees. If the z value of a cursor or icon is simply ignored, the cursor or icon will always be displayed at some fixed depth set by the system.

For example, in a system utilizing a stereoscopic display a cursor or icon could be always displayed at the convergence plane (i.e., a plane in front of the viewpoint and perpendicular to it where there is no disparity between the left and right eyes). This introduces three problems.

In one scenario, where the virtual object is located behind the convergence plane (i.e., all points within the object have a z value less than that of the convergence plane, assuming the standard convention where a negative z value is taken as being into the display screen), the mouse cursor will appear as floating in front of the object, its motion constrained to a plane, and thus never reaching the objects which a user intends to manipulate. This option requires that a user manipulate the virtual object from a distance in front of it, making interactions awkward. This situation is illustrated in FIG. 1A.

On the other hand, if the virtual object is located in front of the convergence plane, the cursor or icon will appear as being behind the object but un-occluded (assuming, obviously, that the cursor or icon is displayed “on top” of the object; otherwise it would not even be visible). This creates incorrect depth-cues for a user and makes stereoscopic convergence strenuous to the eyes. This situation is illustrated, for example, in FIG. 1B. It is noted that in both FIGS. 1A and 1B the cursor is restricted to motion within the convergence plane.

Finally, where the object crosses the convergence plane, the cursor will appear suspended in the middle of object, which is also visually counterintuitive. What is thus needed in the art is a system and method for mapping a 3D visualization system to a standard 2D computing platform, such as laptop or desktop PC, while preserving visual depth cues and displaying cursors and icons at appropriate depths within the data set even though they are controlled by a 2D interface.

### SUMMARY OF THE INVENTION

In exemplary embodiments of the present invention a 3D visualization system can be ported to a laptop or desktop PC, or other standard 2D computing environment, which uses a mouse and keyboard as user interfaces. Using the methods of exemplary embodiments of the present invention, a cursor or icon can be drawn at a contextually appropriate depth, thus preserving 3D interactivity and visualization while only having available 2D control. In exemplary embodiments of the present invention, a spatially correct depth can be automatically found for, and assigned to, the various cursors and icons associated with various 3D tools, control panels and other manipulations. In exemplary embodiments of the present invention this can preserve the three-dimensional experience of interacting with a 3D data set even though the 2D interface used to select objects and manipulate them cannot directly provide a third dimensional co-ordinate. In exemplary embodiments of the present invention, based upon the assigned position of the cursor or icon in 3D, the functionality of a selected tool, and whether and in what sequence any buttons have been pressed on a 2D interface device, a variety of 3D virtual tools and functionalities can be implemented and controlled via a standard 2D computer interface.

### BRIEF DESCRIPTION OF THE DRAWINGS

FIGS. 1A-B depicts problems in displaying a cursor at an arbitrary fixed plane within a 3D data set;

FIGS. 2A-B depicts automatically setting the depth of a cursor using ray casting according to an exemplary embodiment of the present invention;

FIGS. 3A-B depicts drawing a cursor stereoscopically according to an exemplary embodiment of the present invention;

FIG. 4 depicts an exemplary virtual control panel and virtual buttons used to manipulate 3D objects according to an exemplary embodiment of the present invention;

FIGS. 5A-B depict an exemplary mapping of translation in 3D to a two-button mouse according to an exemplary embodiment of the present invention;

FIGS. 6A-B depict an exemplary mapping of rotation in 3D to a two-button mouse according to an exemplary embodiment of the present invention;

FIGS. 7A-B depict an exemplary volume tool operating upon a fully rendered virtual object according to an exemplary embodiment of the present invention;

FIGS. 7C-D depict an exemplary volume tool operating on another exemplary virtual object according to an exemplary embodiment of the present invention;

FIGS. 8A-B depict an exemplary volume tool operating upon a tri-planar display of the exemplary virtual object of FIGS. 7A-B according to an exemplary embodiment of the present invention;

FIGS. 8C-D depict an exemplary volume tool operating upon a tri-planar display of the exemplary virtual object of FIGS. 7C-D according to an exemplary embodiment of the present invention;

FIGS. 9A-B depict use of an exemplary drill tool according to an exemplary embodiment of the present invention;

FIGS. 9C-G depict use of an exemplary drill tool on the exemplary virtual object of FIGS. 7C-D according to an exemplary embodiment of the present invention;

FIG. 10 depicts use of an exemplary ruler tool according to an exemplary embodiment of the present invention;

FIGS. 11A-C depict interactions with the exemplary virtual object of FIGS. 7C-D that has had two points placed upon it according to an exemplary embodiment of the present invention; and

FIGS. 12A-B depict another interaction with the exemplary virtual object of FIGS. 7C-D, where two different points have been placed upon it according to an exemplary embodiment of the present invention.

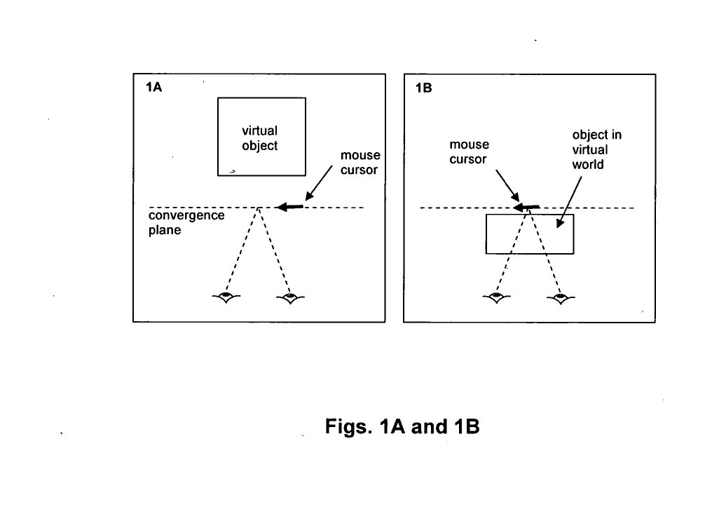

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

In exemplary embodiments of the present invention a 3D visualization system can be implemented on a standard laptop or desktop PC, or other standard 2D computing environment, which uses a mouse and keyboard as interfaces. Such a mapping allows 3D visualization system functionality to be made available on a conventional PC. Such a mapping can, for example, include depth appropriate positioning of cursors and icons as well as assigning various 3D interactive control functions to a mouse and keyboard. In exemplary embodiments of the present invention, a cursor controlled by a mouse, trackball, or other 2D device can be automatically drawn so as to have a contextually appropriate depth in a virtual 3D world, such as would be presented, for example, by a fully functional 3D visualization system.

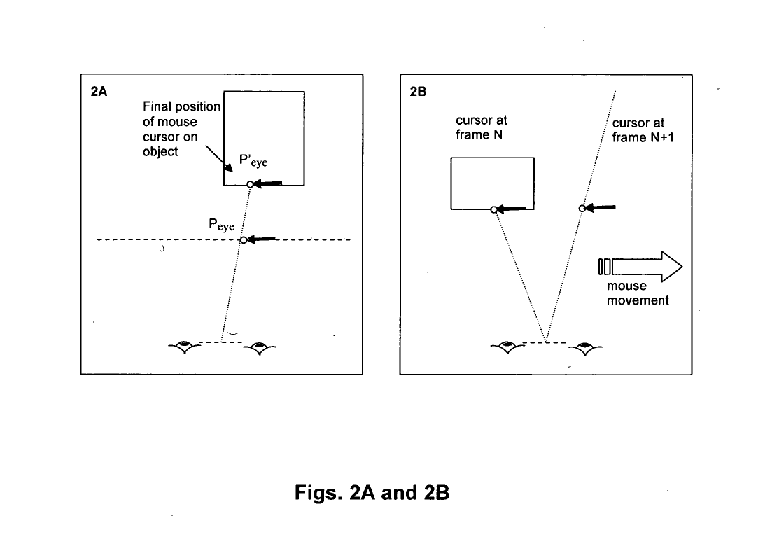

FIGS. 2A and 2B depict an exemplary method for setting cursor depth according to exemplary embodiments of the present invention. First, for example, a mouse's position can be acquired. Given the 2D realm in which a mouse moves, a mouse's position can only specify two co-ordinates, taken to be (x,y). Thus, a mouse's movement on a mouse pad can be mapped to movement anywhere in a plane. It is noted that mapping the mouse's motion to (x,y) is analogous to the mouse's physical movement. While this convention is not strictly necessary, it could be confusing if the 2D mouse motion was mapped to, say (x,z) or (y,z)).

Then, for example, the mouse's position (in the mouse co-ordinate system) can be transformed into a position in the virtual world's eye co-ordinate system. However, unlike the 2D realm of a mouse on a mouse pad, movement in a 3D model space requires the specification of three co-ordinates to locate each point. As noted above, when all a user has is a 2D device to specify position in the 3D realm it is thus necessary for the system to automatically supply the “z” value for the point at which the user seems to be pointing, or a convenient approximation thereof. Thus, for example, continuing with reference to FIG. 2A, a ray can be cast from the viewpoint (middle position between the eyes, shown at the bottom of FIG. 2A) to P_{eye}, the point on a plane in front of the viewer to which the mouse position is mapped (in systems which display stereoscopically the convergence plane can be used for such plane, for example), and beyond. The first hit point (P′_{eye}) of such a ray with any virtual object can then, for example, be set as the new 3D cursor position. This is illustrated, for example, in FIG. 2A.

If such a cast ray does not hit any virtual object, then the previous z value of the cursor can be used. For example, as shown in FIG. 2B, where in frame N+1—because no object was found upon casting a ray through P_{eye}—the previous value (P′_{eye}) that was found in frame N can be used.

In exemplary embodiments of the present invention, once P′_{eye} is found, the cursor can be drawn as a texture image in the virtual world at the position P′_{eye}. It can, for example, be drawn such that its shape is not occluded by other object.

When generating images for a stereoscopic display, normally two eyes and their positions in the world are defined. In exemplary embodiments of the present invention the middle position between the eyes can be taken as the viewpoint and can be calculated from these two positions. The cursor can, for example, be an image or bitmap. In exemplary embodiments of the present invention, such a cursor image can be put in a 3D world by creating a 2D polygon (usually four sided, for example) and then use the image as a texture to map onto the polygon. The polygon can then, for example, be positioned in the 3D world. In exemplary embodiments of the present invention, the polygon can be drawn in a rendering pass, with no depth test, so that it appears unoccluded by any other polygons.

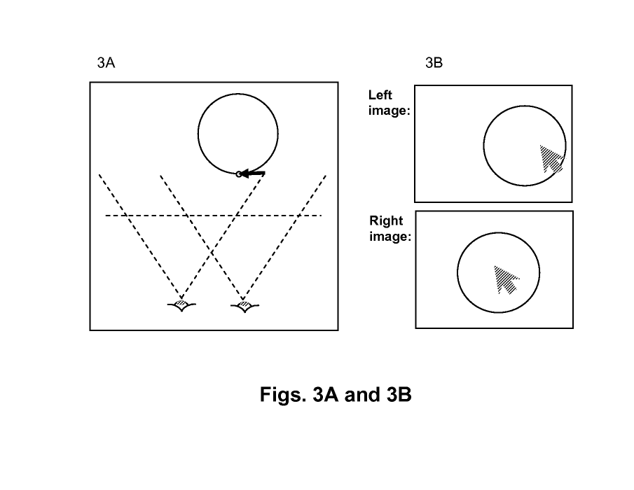

In a system using a stereoscopic display, the cursor can be perceived with depth-cues and thus “falls” or “snaps” on the surface of virtual objects, as is shown in FIG. 3. For objects with a convex surface, such a cursor position does not introduce any occlusion problem and thus makes stereoscopic convergence easy. Furthermore, in exemplary embodiments of the present invention a cursor can be, for example, displayed transparently to create a see-through effect, so that even if the surface is concave and partially occludes the cursor, stereoscopic convergence can be preserved. In exemplary embodiments of the present invention, the size of the cursor can change as a function of the position at which it is displayed. This can give a sense of depth even when the display is not stereoscopic. However, in such a cursor size changing approach, if a cursor is positioned too near the eyes, it can appear as very large. Therefore, in exemplary embodiments of the present invention, some restriction on the maximum size of the cursor can be imposed, as provided below.

In exemplary embodiments of the present invention, the following pseudocode can be used to implement the computation of the depth (“z” position) and control the size of an exemplary cursor. The pesudocode assumes an exemplary stereoscopic system; for monoscopic systems the convergence plane can be, for example, any plane in front of the viewer at a convenient depth.
1. acquire a cursor position (Xₘₒᵤₛₑ, Yₘₒᵤₛₑ) from a mouse or equivalent 2D device;
2. transform this position to a position in the virtual world's eye coordinate system, P_{eye}; such a transformation is a commonly known graphics technique, and can be implemented, for example, using the gluUnProject command of the OpenGL utility library;
3. if this is a first loop (i.e., the first time this process is executed), set the depth component of P_{eye} to be the z value of the stereoscopic convergence plane; otherwise, set the depth component of P_{eye} to the previous depth value of the mouse cursor;
4. cast a ray from the middle position between the eyes through the point P_{eye} and beyond into the virtual 3D world;
5. compute the first hit point of the ray with any virtual object, P′_{eye} (as shown in FIG. 2A). If the ray does not hit any object, set P′_{eye}=P_{eye};
6. compute size of the cursor at P′_{eye}, say SIZE_{cursor};
7. if (SIZE_{cursor}>MAX_{size}), set SIZEcursor=MAXsize; scale cursor by a factor of SIZEcursor;
8. draw the cursor as a texture image at the position P′eye.

It is noted that prior to drawing to the monitor a graphics engine generally has to transform all points from world coordinates to eye coordinates. The eye coordinate system presents the virtual world from the point of view of a user's eye. These points in the eye co-ordinate system can then be projected onto the screen to produce a scene using a perspective projection.

Mapping Virtual Tools' Behavior to a PC Mouse

Using the technique for automatically supplying a cursor or other icon's depth value as described above, a user can thus position a cursor or other icon anywhere within a 3D data set using only a mouse. Given this capability, in exemplary embodiments of the present invention various virtual tools can be selected or engaged, and controlled using such a mouse in conjunction with a keyboard, thus allowing a 3D visualization system to be controlled from a 2D interface.

Virtual tools in 3D visualization systems can be classified as being one of three types: manipulation tools, placement tools and pointing tools. This is true, for example, in the Dextroscope™.

Manipulation Tools

Manipulation tools are those that interact directly on virtual objects. In the Dextroscope™ system, for example, these tools are mapped to the position and control of a controller that can be held in a user's right hand. To illustrate such mappings according to exemplary embodiments of the present invention, in what follows, the following exemplary manipulation tools shall be discussed: Volume tool, Drill and Restorer tool, Ruler tool and Picking tool.

Placement Tools

Placement tools are those that can be used to position and/or rotate one or more virtual objects in 3D space. On the Dextroscope™, for example, a Placement tool can be mapped to the position, orientation and status of the control switch of a 6D controller held in a user's right hand.

Pointing Tool

A Pointing tool can interact with a virtual control panel which is inserted into a virtual world. A virtual control panel allows a user to select form a palette of operations, color look up tables and various visualization and processing operations and functionalities. On the Dextroscope™ for example, whenever a user reaches into a virtual control panel with a pointing tool (a 3D input), the virtual control panel appears and a displayed virtual image of the pointing tool is replaced by an image of whatever tool was selected from the control panel.

In exemplary embodiments of the present invention the selection and control of virtual tools can be mapped to a 2D interface device such as, for example, a mouse. Next described, to illustrate such mappings, are each of a Pointing tool, a Placement tool, a Volume tool, a Drill tool, a Picking tool, and a Ruler tool.

A. Pointing Tool

In a 3D visualization system a user generally points, using a Pointing tool, to a 3D position of a virtual control panel to indicate that it should be activated. For example, such a pointing tool can be a virtual image of a stylus type tool commonly held in a user's right hand, and used to point to various virtual buttons on a virtual control panel. Once a control panel button is chosen for a virtual tool of some kind, the control and position and orientation of the chosen tool can be mapped to the same right hand stylus, and thus the virtual image can be changed to reflect the functionality of the chosen tool. For example, a stylus can be used to select a drill tool from a virtual control panel. Prior to such a selection, a virtual image of a generic stylus is displayed in the 3D virtual world whose position, orientation track that of the physical tool being held in the user's right hand. Once the drill tool is selected (by, for example, pushing on the virtual control panel with the virtual stylus) the image of the stylus can change to appear as a virtual drill, whose position and orientation still track the physical tool held in the user's right hand, but whose drilling functionality can also be controlled by physical buttons or other input/interface devices on the physical tool or stylus. Once the drill tool is no longer selected, the virtual image of the user's right hand tool can, for example, return to the generic pointer tool.

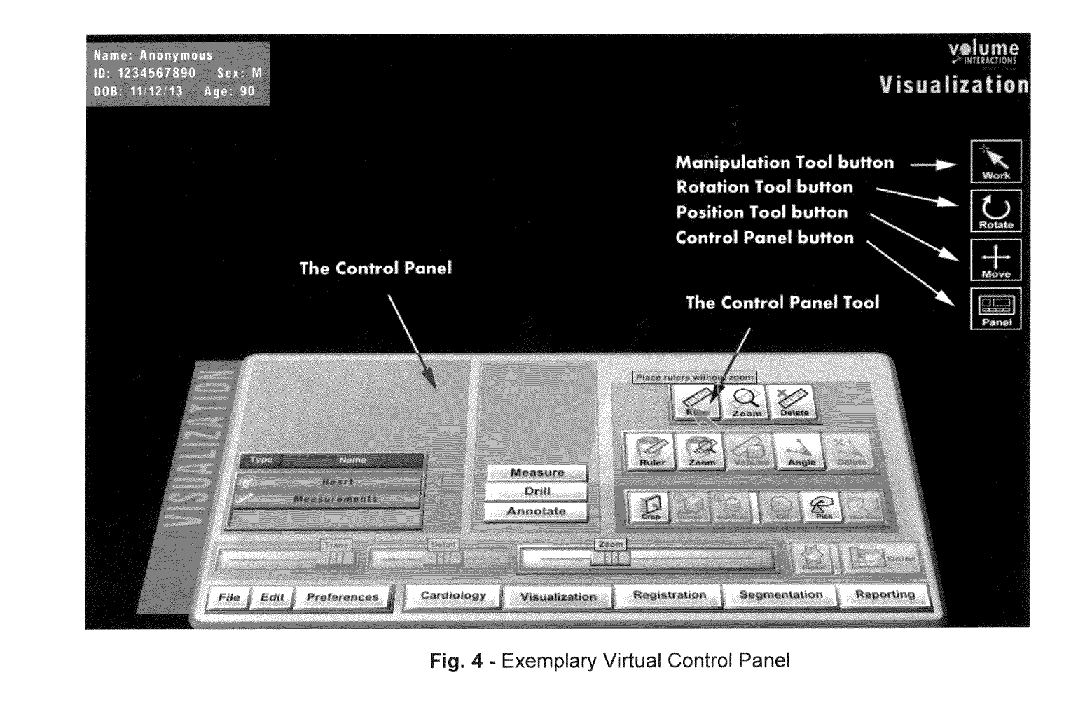

In 3D visualization systems the virtual control panel can be activated, for example, by a physical tool being brought into a certain defined 3D volume. This requires tracking of the physical tool or input device held in a user's hand. However, in the case of mouse/keyboard 2D interface, without having a tracking device to signal to a 3D visualization system that a user wishes to see (and interact with) a virtual control panel, it is necessary to provide some other means for a user to call up or invoke a control panel. There are various ways to accomplish this. Thus, in exemplary embodiments of the present invention, a button on the right side of the screen can be provided to invoke a virtual control panel whenever it is clicked, such as is shown, for example, in FIG. 4 by the “control panel” button provided at the bottom of the four buttons shown on the right of the figure. Alternatively, for example, a user can depress a defined key on the keyboard, such as, for example, the space bar, to invoke a control panel. In general, because in a 3D visualization system a virtual control panel has a 3D position, whenever a 2D controlled 3D cursor reaches into that position (by being projecting onto it, as described above) then, for example, a control panel can be activated.

In exemplary embodiments of the present invention, interaction with a virtual control panel via a mouse controlled cursor can be easily accomplished, inasmuch as a cursor can, using the techniques described above, be automatically positioned on the face of the selected button, as shown in FIG. 4, for example, where a cursor (functioning as a “pointer tool”) points to the ruler button of the control panel (said ruler button being generically labeled as “The Control Panel Tool” in FIG. 4).

B. Placement Tool

As noted, a mouse only provides two degrees of interactive freedom. In order to position and rotate a virtual object, which requires six degrees of interactive freedom, in exemplary embodiments of the present invention a 3D virtual Placement tool can, for example, be decoupled into a Positioning tool and a Rotation tool to more easily map to a 2D interface device such as a mouse.

B1. Positioning Tool

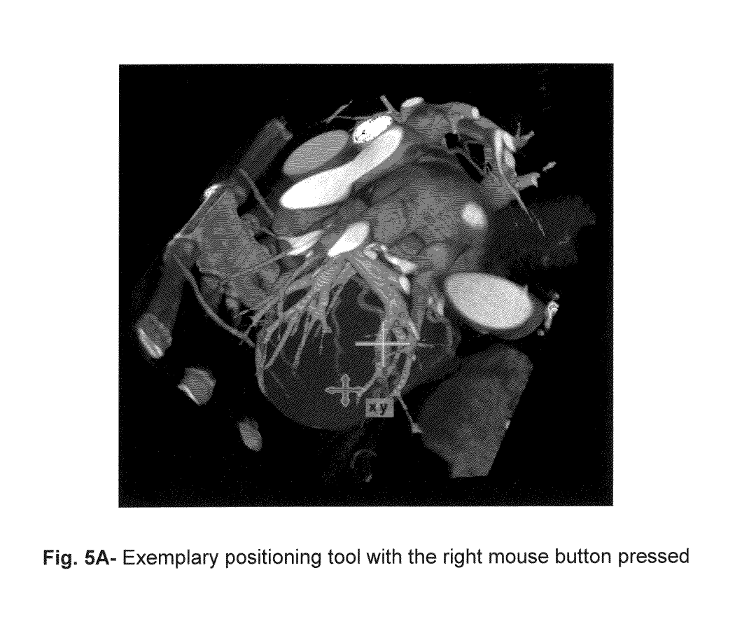

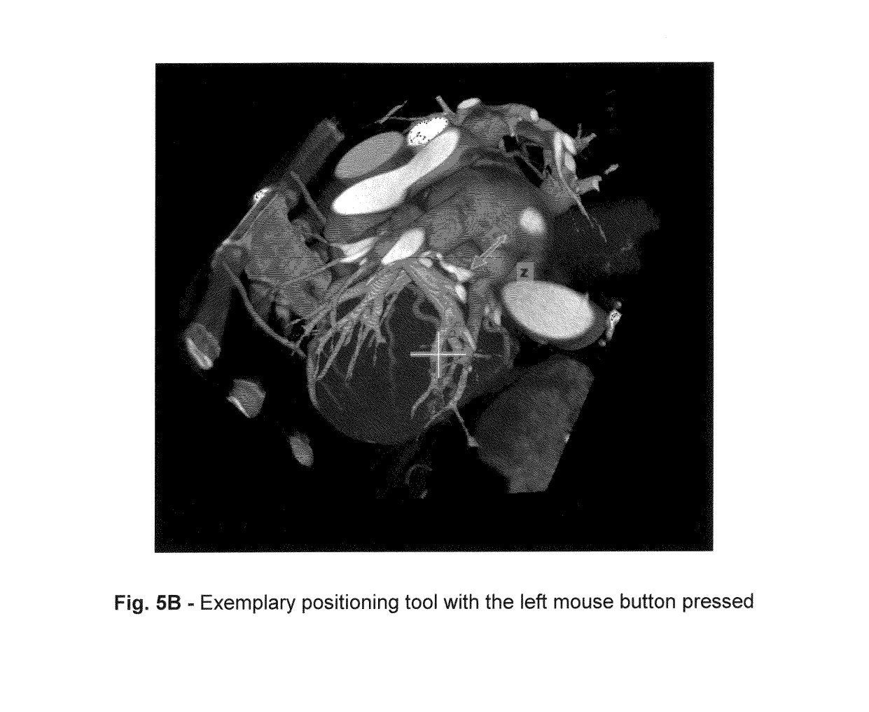

Thus, in exemplary embodiments of the present invention, by sliding a mouse horizontally or vertically and holding down a defined button, for example its left mouse button, a Positioning tool can move a virtual object horizontally or vertically. Furthermore, for example, two outer regions on each of the left and right sides of the screen can be defined, such that if the Positioning tool slides vertically in either of these regions, the virtual object can be caused to move nearer towards, or further away, from the user. These functions are depicted in FIGS. 5A-B, respectively. Alternatively, a user can press a defined mouse button, for example the right one, to achieve the same effect. Thus, in FIG. 5A, where a horizontal/vertical move is chosen, for example by pressing the left mouse button, an “xy” icon appears (cross made of two perpendicular double sided arrows labeled “xy”). Similarly, in FIG. 5B, where a nearer/farther (in a depth sense) translation is chosen, for example, by pressing a left mouse button or by moving the Positioning tool to one of the active regions as described above, a “z” icon can, for example, appear (double sided arrow labeled “z”).

It is noted that in FIGS. 5A and 5B the large cross in the center of the frame is not the mouse controlled cursor. It indicates the point on the object that can be used, for example, as a focus of zoom (FOZ). When a zooming function is used to zoom an object in or out, the object will move such that the FOZ will be at the center of the “zoom box.” This is an important feature, as it controls which part of the object to zoom into/out of view. This is described more fully in U.S. patent application Ser. No. 10/725,773, under common assignment herewith. In exemplary embodiments of the present invention, when any move is implemented via a Positioning tool, a FOZ icon can appear, as in FIG. 5, and a user can then use the Positioning tool to move the object relative to the icon to select a center of zoom on the object.

B2. Rotation Tool

In exemplary embodiments of the present invention, by sliding a 2D device such as a mouse horizontally or vertically, and holding down, for example, one of its buttons, for example the left button, a Rotation tool can rotate a virtual object either horizontally (about the x axis) or vertically (about the y axis). Furthermore, to signal a rotation about the z axis, in similar fashion to the case of the Positioning tool, as described above, two outer regions can be defined, for example, on the left and the right sides of the screen such that if the Rotation tool slides vertically, i.e., the mouse is rolled vertically down the screen, in either of these regions, a roll rotation (i.e., rotation about the z axis) can be performed on the virtual object. Alternatively, for example, a user can press the right mouse button to achieve the same effect.

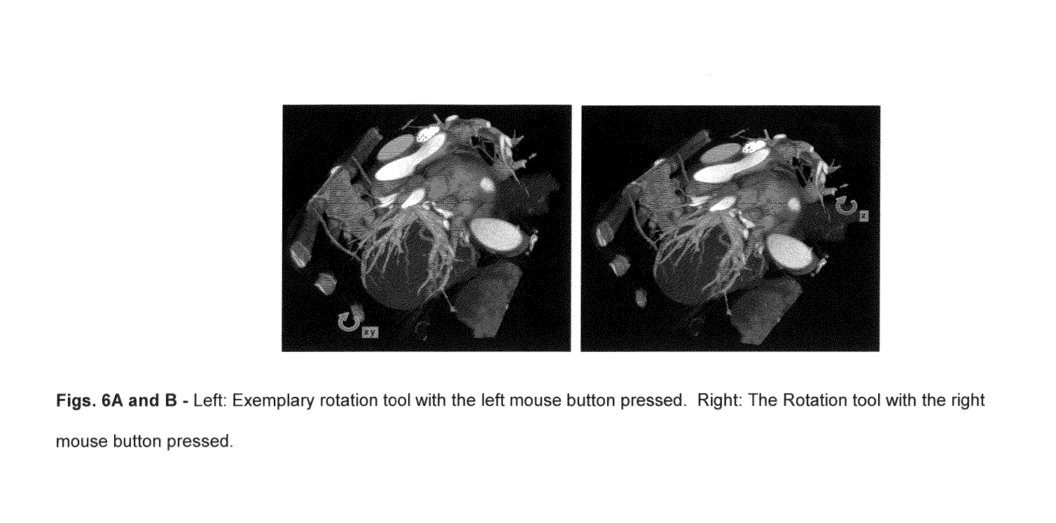

Exemplary Rotation tool functionality is shown in FIGS. 6A and B, where the left image shows the result of a Rotation tool with the left mouse button pressed and thus implementing a rotation about either the x or y axes (depending on which direction the mouse is moved), and the right image shows the result of a Rotation tool with the right mouse button pressed thus implementing a rotation about the z axis. In exemplary embodiments of the present invention, in order to allow a user to switch between a Manipulation tool, a Positioning tool and a Rotation tool, three buttons on, for example, the right side of the display screen can, for example, be provided. This exemplary embodiment is depicted in FIG. 4. In this exemplary embodiment, a user can, for example, click on the appropriate button on the right side of the screen to activate the appropriate tool. The three buttons can, for example, always be visible on the screen regardless of which mode the tool is actually in, if any. Alternatively, for example, a user can keep the keyboard's<ctrl> key, for example, pressed down to switch to the Positioning tool, or keep the <shift> key, for example, pressed down to switch to the Rotation tool. In such a mapping, when the <ctrl> or <shift> key is released, the system can, for example, revert to the Manipulation tool. First, a user can, for example, choose a manipulation tool via the control panel. He does not need to click on the Rotation Tool or Position Tool button, but can, for example, press the <ctrl> or <shift> key at any time to switch to rotation or position tool mode. The Manipulation tool button need only be used if the user has clicked on the Position tool button or Rotation tool button and later wanted to use the Manipulation tool he had been using previously.

C. Volume Tool

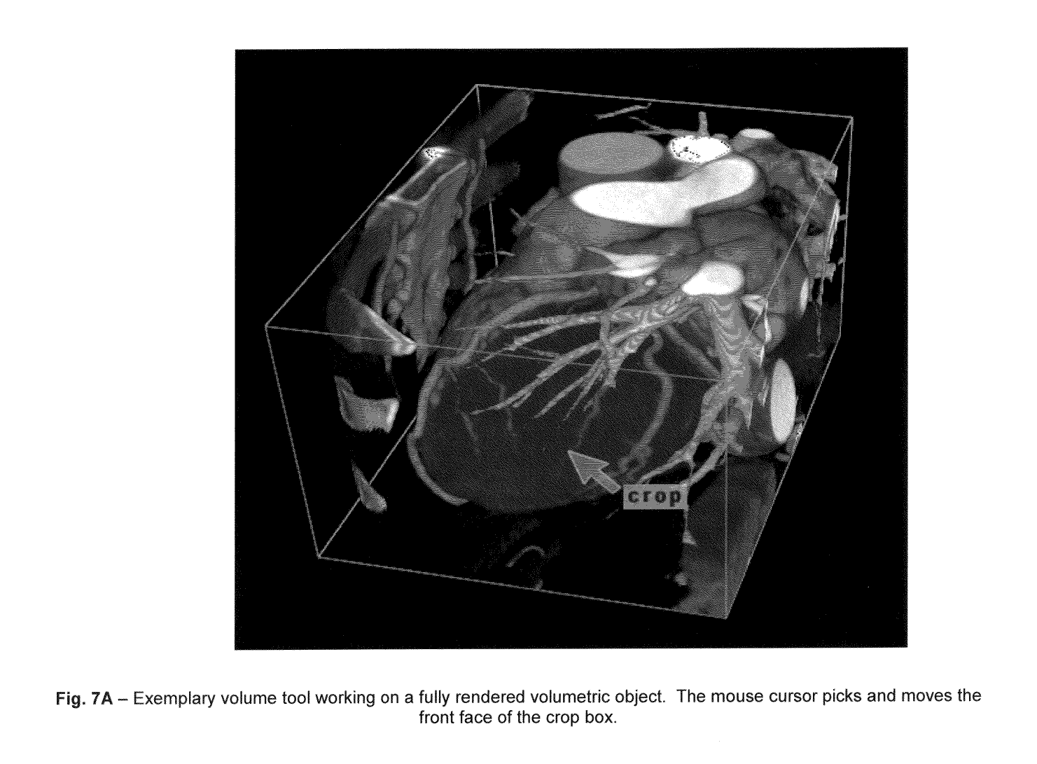

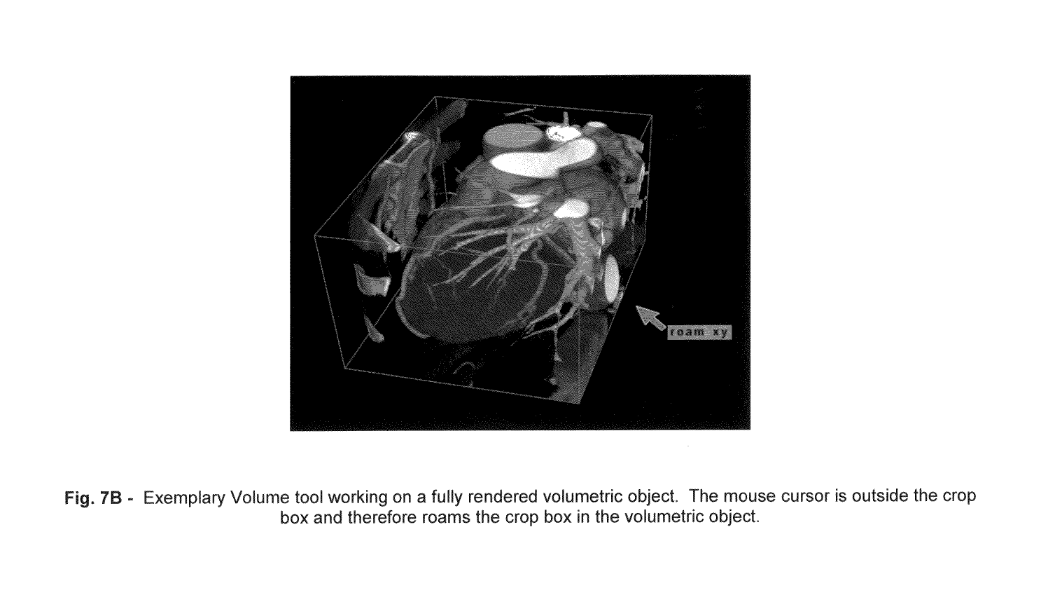

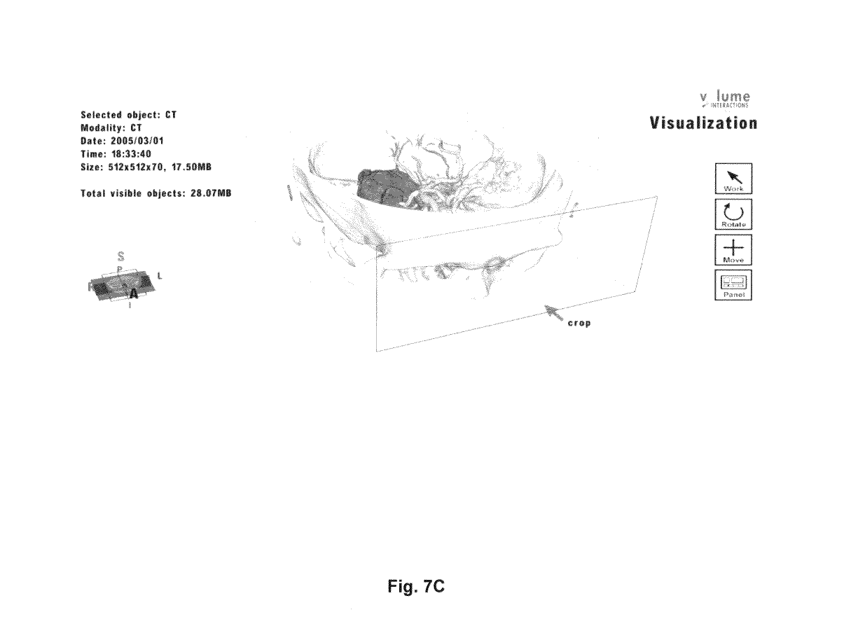

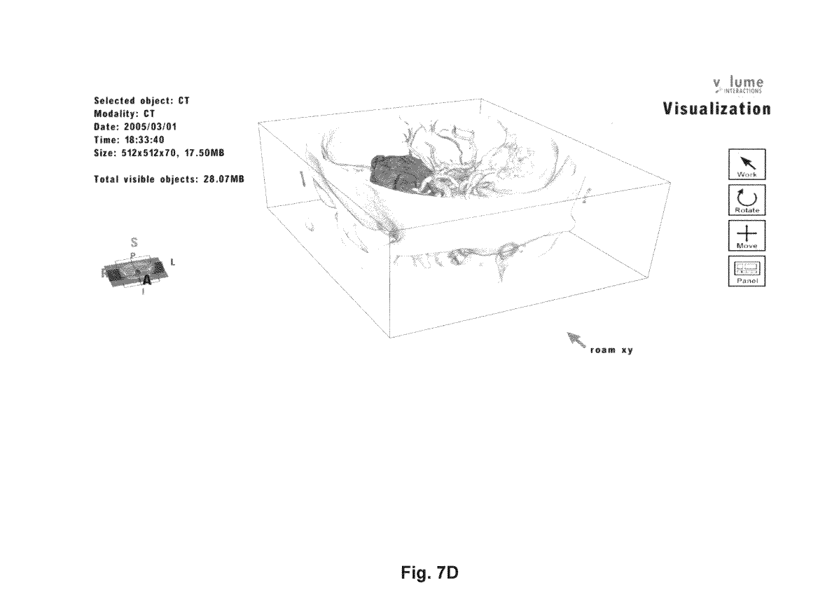

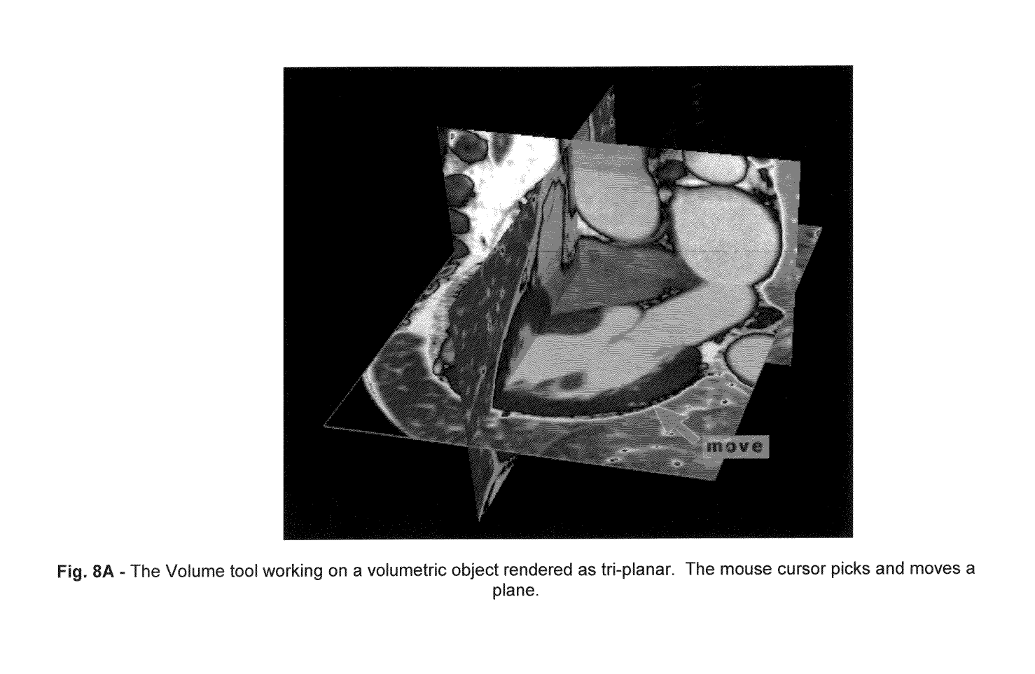

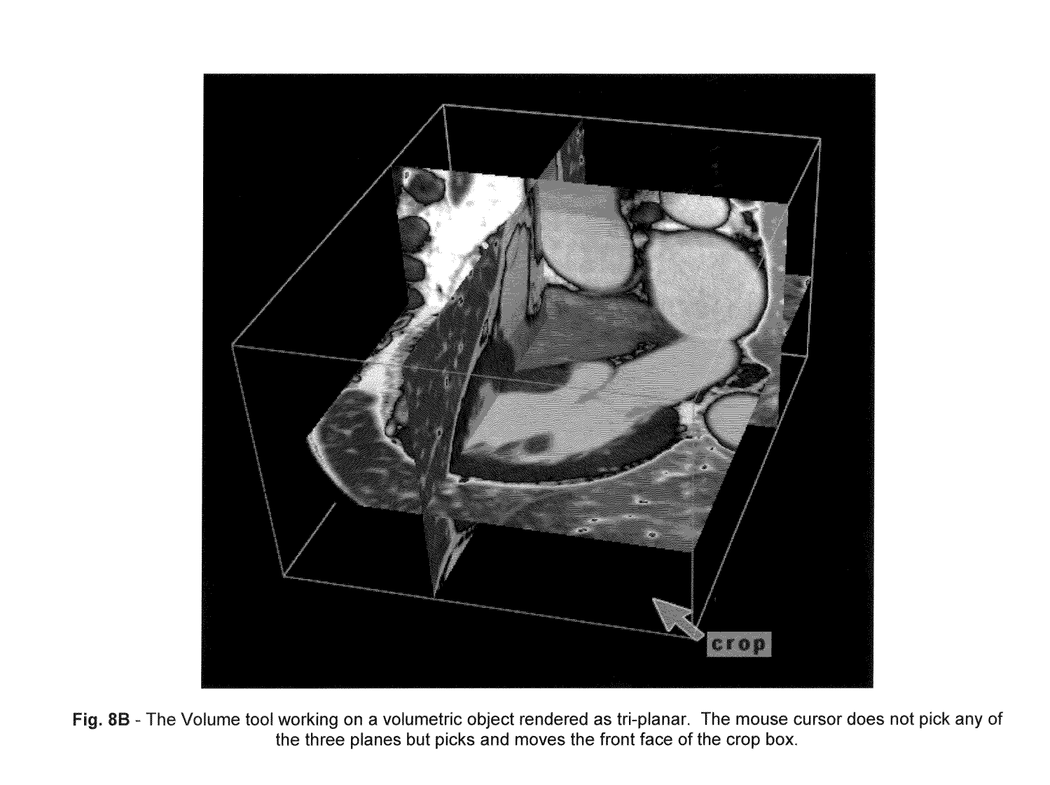

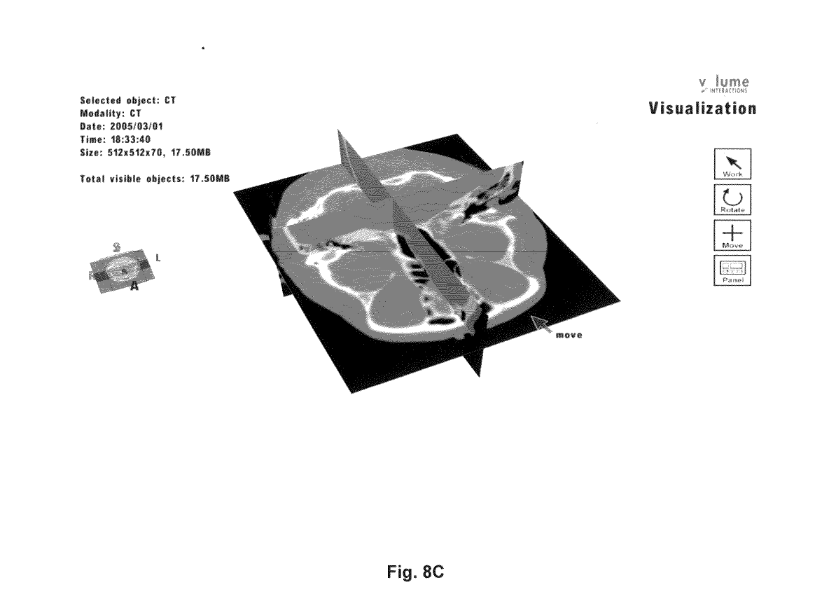

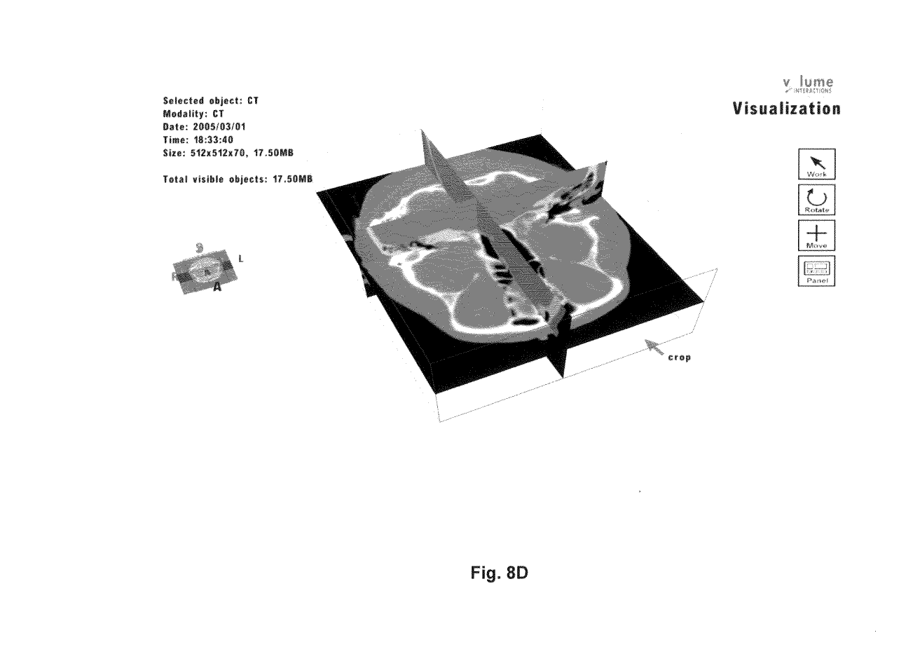

In exemplary embodiments of the present invention a Volume tool can be used to interact with a 3D object. A Volume tool can be used, for example, to crop a volume and to move its tri-planar planes, when depicted in tri-planar view. Any 3D object can be enclosed in a bounding box defined by its X, Y and Z maximum coordinates. It is common to want to see only a part of a given 3D object, for which purpose a “cropping” tool is often used. Such a cropping tool allows a user to change, for example, the visible boundaries of the bounding box. In particular, a Volume tool can allow a user to crop (resize the bounding box) the object or roam around it (to move the bounding box in 3D space without resizing it). An exemplary Volume tool performing cropping operations is shown in FIGS. 7A and 7B, and an exemplary Volume tool performing roaming operations on a different volumetric object is shown in FIGS. 7C and 7D. If the 3D object is a volumetric object, that is, it is made of voxels, then two types of volumetric displays are possible, and hence two types of interactive manipulations are generally required. One type of volumetric display is known as fully rendered, where all the voxels of the object (within the visible bounding box) are displayed. The second type of volumetric display is a tri-planar rendering, in which three intersecting orthogonal planes of the object are displayed. FIGS. 8A and B depict exemplary tri-planar views of a volumetric object, and FIGS. 8C and D depict exemplary tri-planar views of another volumetric object (the same one depicted in FIGS. 7C and 7D). If a 3D object is rendered in a tri-planar manner, such a Volume tool can be used, for example, to perform, for example, two operations. Cropping the bounding box of the object, or moving any one of its three intersecting planes. In exemplary embodiments of the present invention the implementation of a Volume tool controlled by a mouse can differ from that in a standard 3D visualization system. In a standard 3D visualization system, a Volume tool generally casts a ray from its tip and if the ray touches the side of the crop box, it will pick that side and perform a cropping operation. If the Volume tool is in the crop box of the object, it will perform a roaming operation. This cannot be done in a 2D implementation inasmuch as a mouse controlled cursor can never reach into a crop box, as it always falls (snaps) onto surfaces, as described above. Thus, in exemplary embodiments of the present invention, the following pseudocode can be used to control a Volume tool via a mouse:
1. Select a volumetric object, called, for example, VOL.
2. IF VOL is fully rendered (as shown, for example, in FIG. 7):
a. Project a ray from the viewpoint through the cursor position;
b. Find the face of the crop box of VOL which intersects the ray;
c. WHILE the mouse button is pressed:
   IF a face of the crop box of VOL was found, move the face of the crop box according to the cursor movement;
   ELSE roam the entire crop box relative to VOL according to the cursor movement;
3. IF VOL is rendered in a tri-planar manner (as shown, for example, in FIG. 8):
a. IF the cursor touches any of the planes, and WHILE the mouse button is pressed, move the plane according to the mouse movement;
b. Project a ray from viewpoint through the cursor position;
c. Find the face of the crop box of VOL which intersects the ray;
d. IF the face is found and WHILE the mouse button is pressed, move the face of the crop box according to the cursor movement.

As noted, FIGS. 7A and 7B depict an exemplary Volume tool working on a fully rendered exemplary volumetric object, here a heart, and FIGS. 7C and 7D depict an exemplary Volume tool working on another fully rendered exemplary volumetric object, here a human head. Thus, FIGS. 7A and 7C depict a mouse controlled cursor picking and moving the front face of a crop box (note in FIG. 7A the front face is selected and thus its borders shown in red, and in FIG. 7C the front face is selected and thus its borders shown in grey), and FIGS. 7B and 7D show the mouse cursor outside the crop box and therefore roaming the crop box through the volumetric object.

FIG. 8 illustrate an exemplary Volume tool working on exemplary volumetric objects rendered in tri-planar mode. In FIGS. 8A and 8C the cursor picks and moves a horizontal (xz) plane, and in FIGS. 8B and 8D the mouse controlled cursor has not picked any plane (there was none that intersected with a projection from the viewpoint through the cursor position) and thus picks and moves the front face of the crop box. Thus, in FIGS. 8B and 8D no plane was picked because the displayed cursor position does not snap onto any of the three depicted tri-planar planes. If a user wanted to, for example, pick a plane from the indicated cursor position, the tri-planar volumetric object could be rotated (causing an intersection of a ray from viewpoint through the cursor position with the plane) until a desired plane is selected.

D. Drill Tool

As noted above, a Drill tool can be used to make virtual spherical holes on a selected volumetric object, and it can undo those holes when placed in restorer mode. The implementation of a Drill tool using a mouse is basically the same as that on a 3D visualization system except that it is useful to restrict the depth of the mouse cursor so that it will not suddenly fall beyond any holes created in the object (i.e., into the virtual world in a direction away from the viewpoint). This unwanted behavior can happen, for example, when drilling a skull object that contains a large cavity. Without such a restriction, a cursor or icon could fall through the hole, then drop through the entire cavity and snap onto the opposite side of the skull (on its interior). It would be more intuitive to keep the cursor or icon at or near the surface of the object that has just been drilled, even if it is “floating” above the hole that was just made by the Drill. In exemplary embodiments of the present invention, the following pseudocode can be used, for example, to map a Drill tool to a mouse, and restrict its depth range to within [−THRESHOLD, THRESHOLD] of the z position that it had at the point it started drilling:

Get a selected volumetric object, say VOL;

IF the mouse button is pressed, set Z=mouse cursor's depth;

WHILE mouse button is pressed,
Set Z′=mouse cursor's depth;
IF (Z′>Z and Z′−Z>THRESHOLD) set Z′=Z+THRESHOLD;
ELSE IF (Z′<Z and Z−Z′>THRESHOLD) set Z′=Z−THRESHOLD;
Make a spherical hole on VOL at the position of the cursor.

Choosing THRESHOLD to be sufficiently small will keep the Drill tool icon near the position it had when it had a surface to drill. As THRESHOLD becomes smaller, the cursor or icon is effectively held at the z position it had when drilling began, so as to “hover” over (or under, depending on the surface) the hole that has been created.

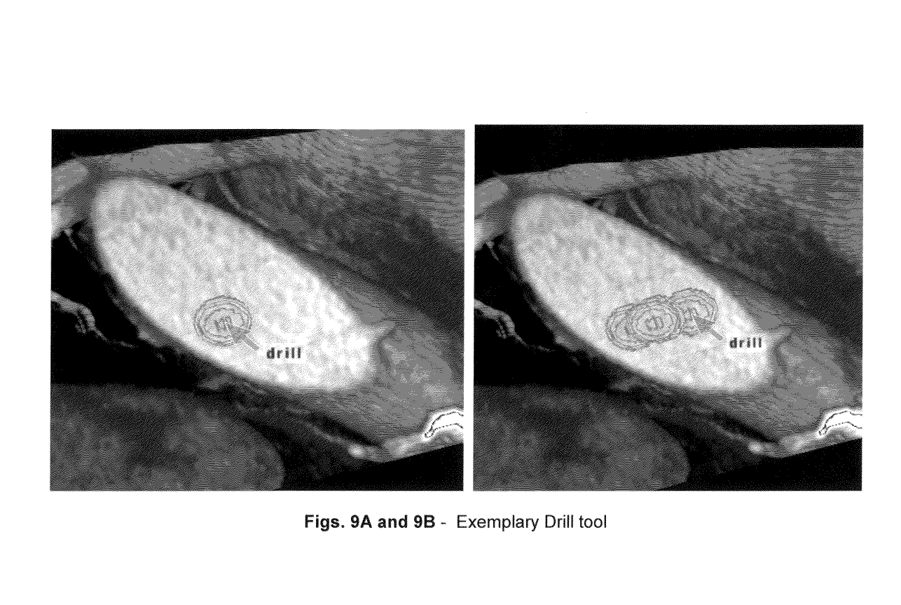

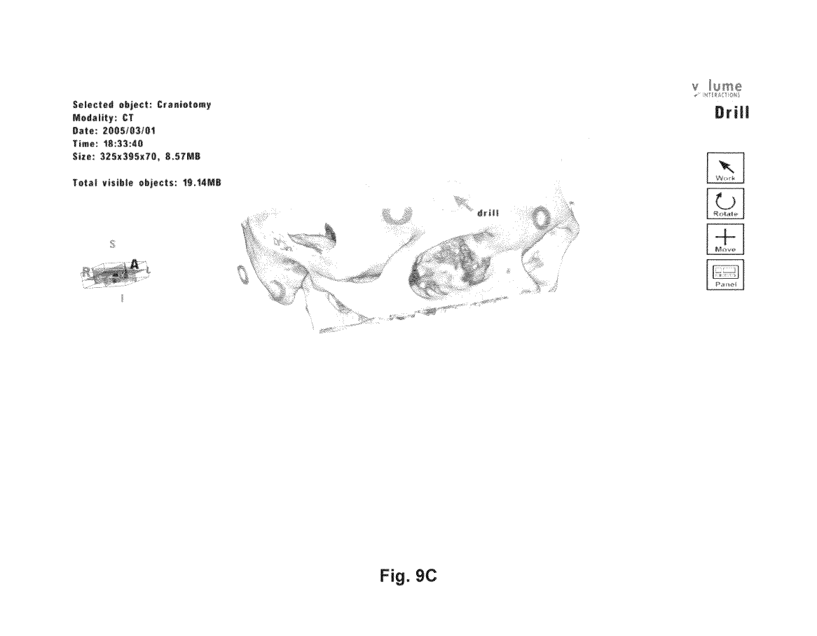

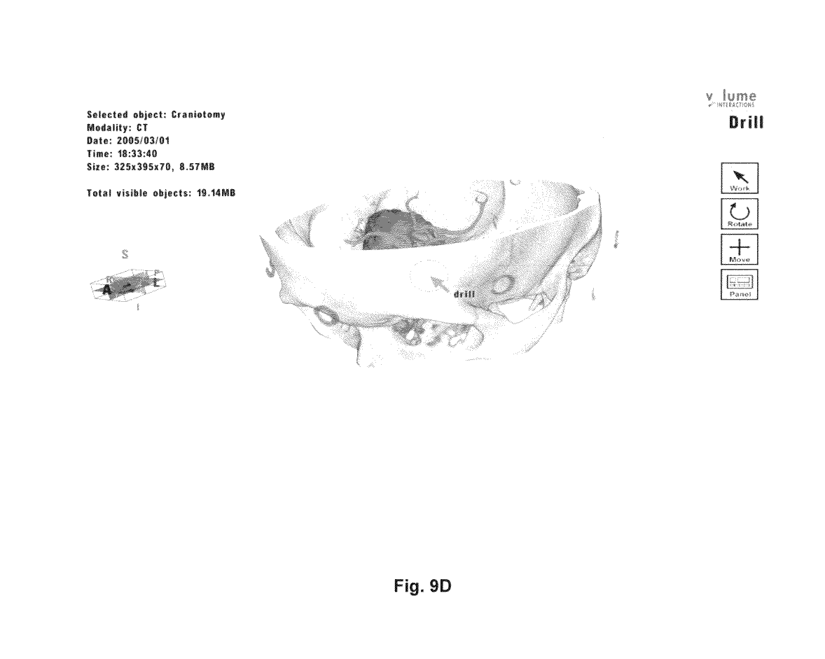

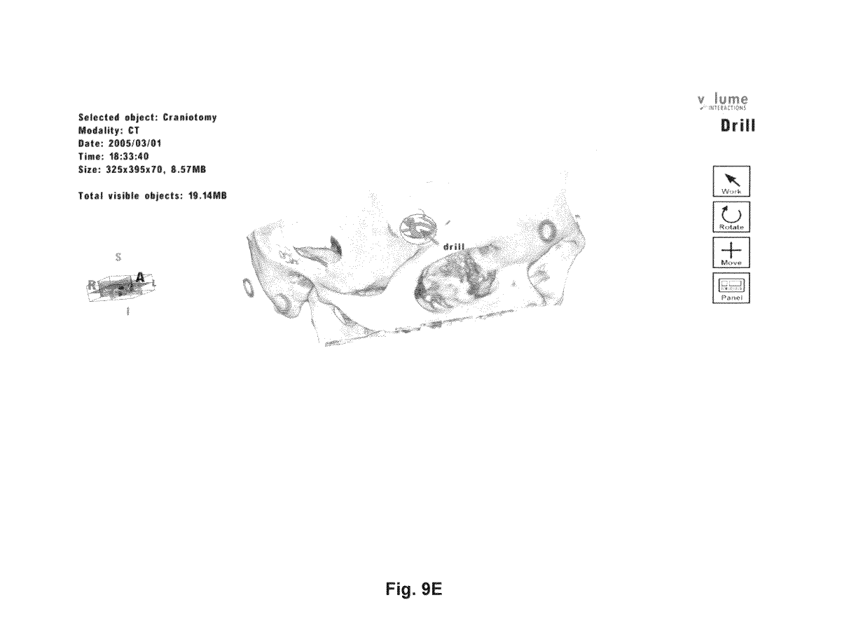

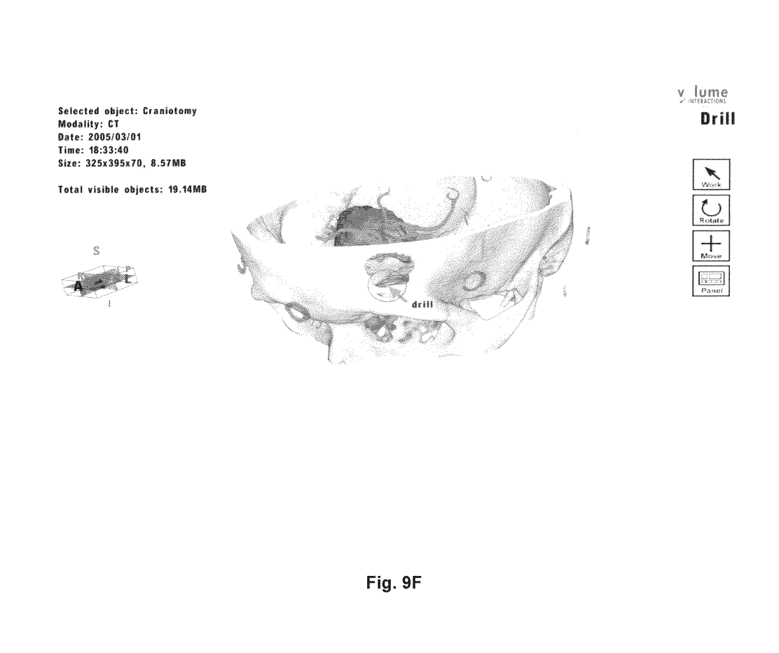

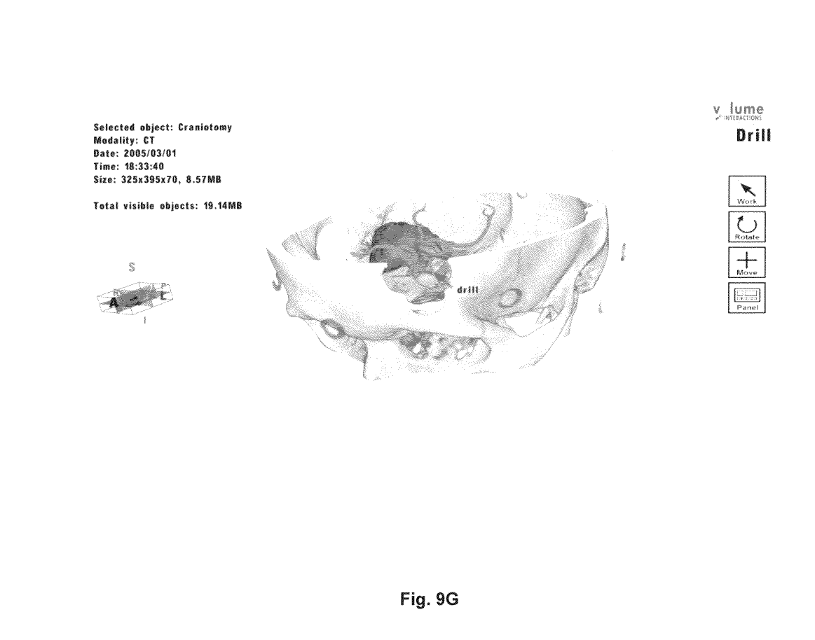

FIGS. 9A (left image) and 9B (right image) illustrate the use of an exemplary 3D Drill tool mapped to a mouse. With reference thereto, there is a spherical eraser icon provided around the tip of the cursor. FIG. 9A shows the effect of an exemplary mouse button being pressed and drilling out a hole in a volumetric object. FIG. 9B shows the effect of a mouse being moved to the right while its button being continually pressed, which drills out a trail of holes, akin to the effect of a router.

Similarly, FIGS. 9C-9G depict a series of interactions with a different volumetric object (i.e., the head of FIGS. 7C-D). In FIGS. 9C and 9D the Drill tool is held over the skull, but the mouse button is not pressed. Thus, only the Drill tool icon, the circular area, is visible, but the volumetric object is not affected. In FIGS. 9E-9G drilling operations are performed. In the depicted exemplary embodiment the Drill stays near the z position it had originally, when drilling began, even though the center of the Drill tool icon is hovering over a hole, and in FIG. 9G the entire Drill tool icon is hovering over a hole. It is noted that in exemplary embodiments of the present invention a Drill tool icon can be said to be located where its center point is (here the center of the circle) and thus need to be held “hovering” as in FIGS. 9E and 9F when there is no longer any surface at the z position of its center, or alternatively, it can remain at a z position of any portion of a surface within the entire circle of its icon, and only need to be “hovered”, such as is illustrated by the pseudocode above, or, for example, as in FIG. 2B, when the entire circle, for example, is above a hole.

E. Ruler Tool

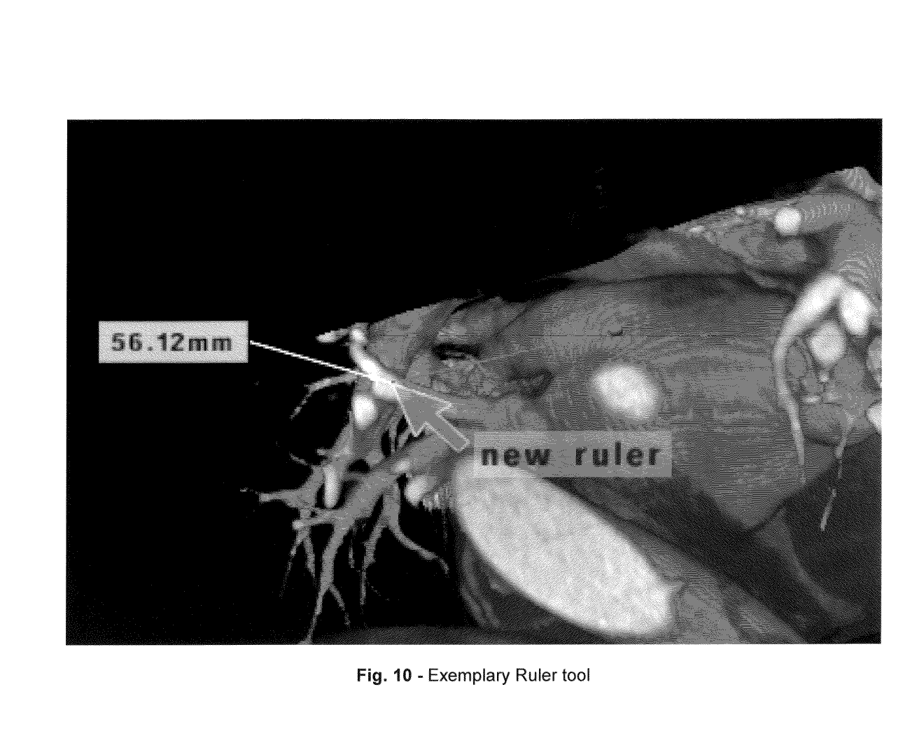

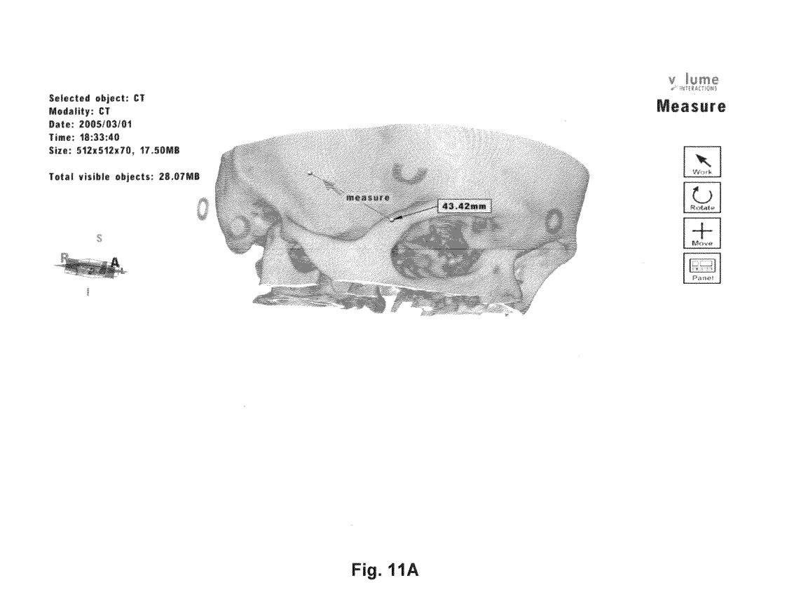

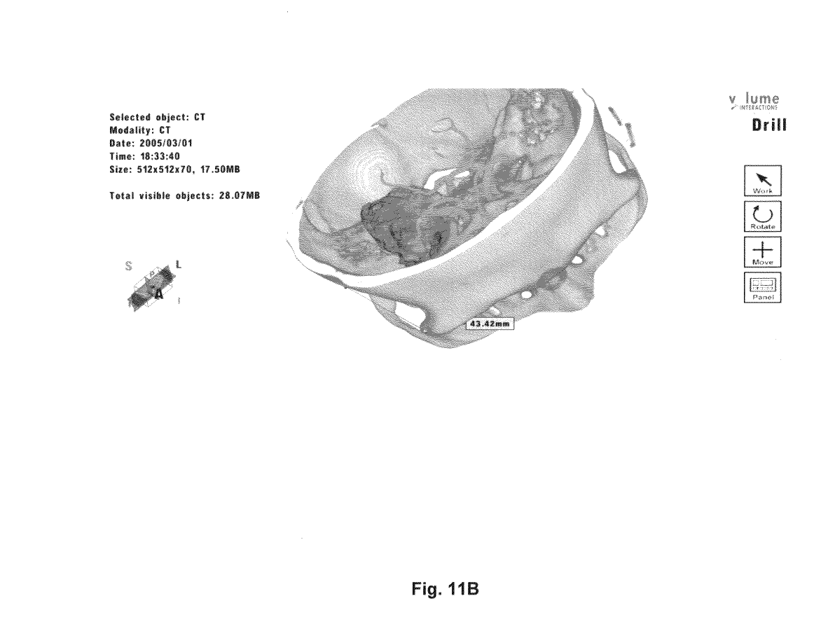

A Ruler tool can measure distance in 3D space by placing a starting point and an ending point of the distance to be measured. Variants of the Ruler tool can measure distances between two points along a defined surface. This functionality is sometimes known as “curved measurement,” as described in U.S. patent application Ser. No. 11/288,567, under common assignment herewith. In either variation, a Ruler tool or its equivalent needs to facilitate the placement of two points on a surface. In exemplary embodiments of the present invention, putting points on surfaces can be made trivial using a mouse (or other 2D device) controlled cursor, inasmuch as in exemplary embodiments of the present invention such a cursor can be automatically “snapped” onto the nearest surface behind it, as described above and as illustrated in FIG. 2. Exemplary Ruler tool functionality is depicted in FIG. 10, where two points have been set. Once the second point is set (in FIG. 10 the leftmost point) the distance between them can be displayed, for example.

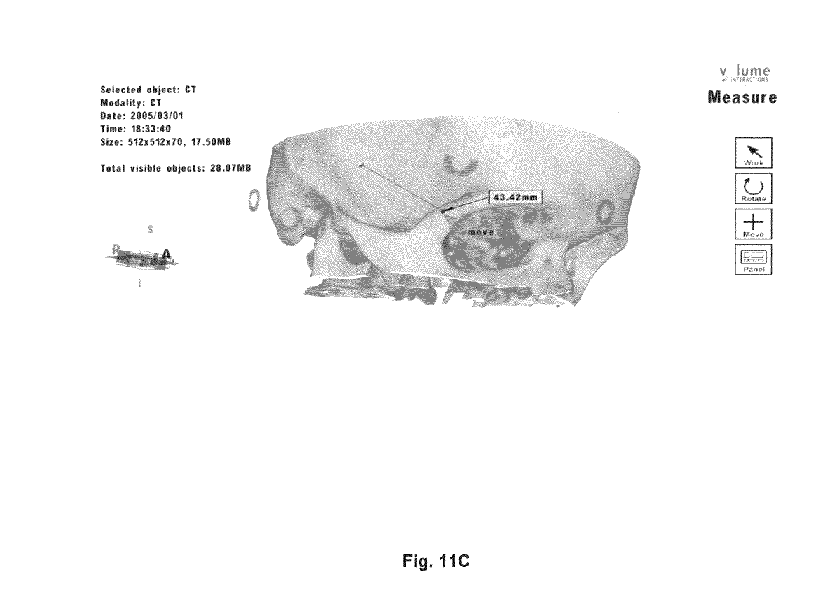

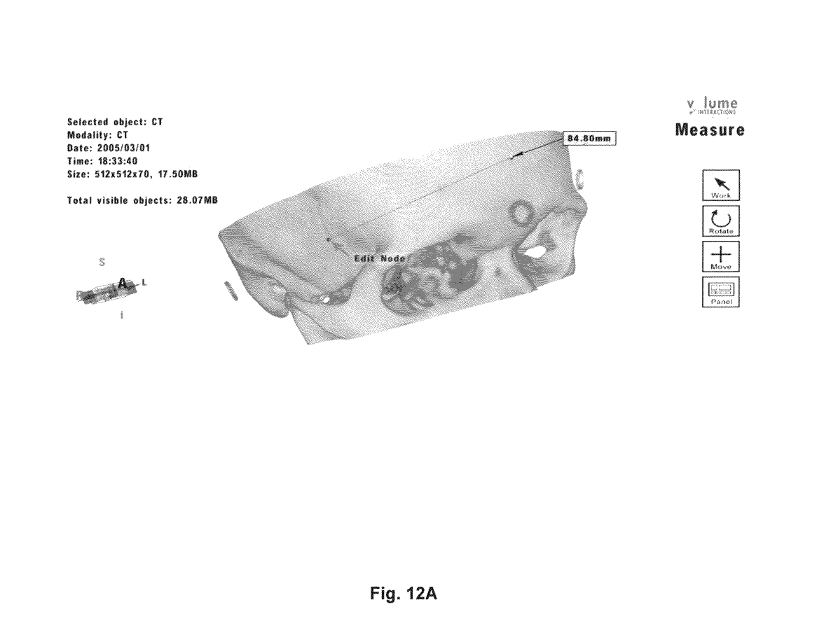

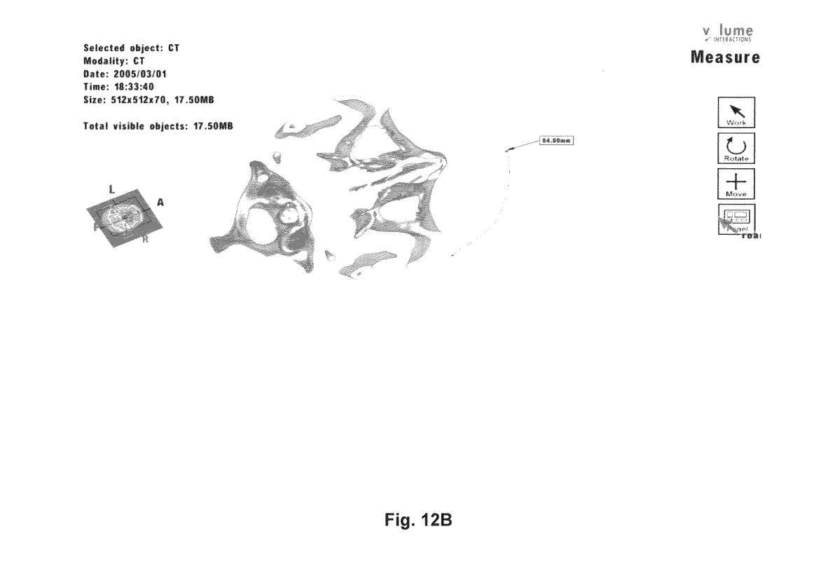

FIGS. 11A-C depict a series of interactions with a volumetric object that has had two points placed on it. Once the points are placed they remain fixed as the object is rotated and/or translated. FIGS. 12A-B depict a series of interactions with the volumetric object that has had two different points placed on it. FIG. 12B shows the object of FIG. 12A after rotation and a visualization change, so that a large part of the skull is cropped away, but the two selected points, and the surface measurement line, remain.

F. Picking Tool

A Picking tool can, for example, be used to pick or select any virtual object from among a group of virtual objects, and then position and orient such object for interactive examination. In exemplary embodiments of the present invention determining the picked, or selected, object using a mouse can be made trivial inasmuch as the system inherently knows which virtual object the mouse's cursor has been snapped onto, as described above. If the two objects do not overlap completely, a user can always find a point where the object that is desired to be selected is not covered, and then pick it. In exemplary embodiments of the present invention, translations can be mapped to a 2D interface, such as a mouse, as follows. By sliding a mouse horizontally or vertically and keeping, for example, its left button down, a Picking tool can be directed to move a picked object horizontally or vertically. To move the picked object nearer towards, or further away from, a user (i.e., movement along the depth or “z” direction), he can, for example, slide the mouse in a defined direction (either horizontally or vertically) while pressing, for example, the right mouse button.

In exemplary embodiments of the present invention, to rotate a picked object for examination, a user can, for example, slide a mouse horizontally or vertically while pressing down the <alt> key on a keyboard and a left mouse button. To perform a roll movement on the picked object, a user can, for example, slide the mouse while pressing down the <alt> key and right mouse button.

Implementations of functionalities of other 3D visualization and manipulation tools using a 2D interface, such as a mouse, can be effected in similar fashion as the functions and tools that have been described above. Such other tools can include, for example, tools to:

Insert annotation labels;

Delete measurements;

Measure angles;

Restore a drilled object; and

Manually register two objects,

and other virtual tools and 3D functionalities as are known in the art, such as, for example, those implemented on the Dextroscope™.

While this invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed:

1. A method of positioning a cursor or other icon in a 3D virtual world that is being interactively visualized using a 2D interface, comprising:
acquiring a first (x,y) position from a 2D device;
transforming said first position to a second (x,y) position in a plane within a 3D virtual world;
obtaining a (x,y,z) position in the virtual world by projecting from a virtual eye through the second (x,y) position into the 3D virtual world to obtain a hit point;
positioning a cursor or other icon on the hit point.

2. The method of claim 1, wherein if no hit point is found the cursor or icon is positioned on the projection from the virtual eye at a defined z value.

3. The method of claim 2, wherein the defined z value is a function of the operation being performed in the virtual world.

4. The method of claim 1, wherein if no hit point is found the cursor or other icon is positioned at its previous position.

5. The method of claim 1, wherein the virtual world is displayed stereoscopically and wherein if no hit point is found the cursor or icon's is positioned along the projection from the virtual eye at a stereoscopic convergence plane.

6. A method of operating upon an object in a 3D data set using a 2D interface, comprising:
selecting a 3D virtual tool;
obtaining a first (x,y) position from a 2D device;
transforming the first (x,y) position to a second (x,y) position in a plane within a 3D virtual world;
obtaining a (x,y,z) position in the virtual world by projecting from a virtual eye through the second (x,y) position into the 3D virtual world until a 3D object is hit; and
operating on the object based upon the (x,y,z) position and the functionality of the virtual tool selected.

7. The method of claim 6, wherein the 3D virtual tool is a picking tool, the (x,y,z) position is on the surface of the object and the operation includes picking the object.

8. The method of claim 6, wherein the 3D virtual tool is a cropping tool, the (x,y,z) position is on the surface of a bounding box for the object, and the operation includes moving a plane of the bounding box.

9. The method of claim 6, wherein the 3D virtual tool is a volume tool, the (x,y,z) position is either on a surface of a crop box or outside of the crop box of a volume rendered object, and the operation is either moving a crop box plane or roaming a crop box through the virtual world.

10. The method of claim 6, wherein the 3D virtual tool is a volume tool, the (x,y,z) position is either on a surface of a plane of a tri-planar object, and the operation is either moving a plane of the tri-planar object or roaming a crop box.

11. The method of claim 6, wherein the 3D virtual tool is a drill tool, the (x,y,z) position is on a surface of an object, and the operation is drilling into the object within a defined distance surrounding the cursor position while a defined button on a mouse is pressed.

12. The method of claim 11, wherein the z position of the cursor is limited to be within a defined distance from the z position of the point at which the drilling operation began.

13. The method of claim 6, wherein the 3D virtual tool is a volume tool, the (x,y,z) position is on or near a volume rendered object, and the operation is:
while a defined mouse button is pressed:
if a face of the crop box of the volume rendered object is found, move the face of the crop box according to the cursor movement;
else roam the entire crop box relative to the volume rendered object according to the cursor movement.

14. The method of claim 6, wherein the 3D virtual tool is a volume tool, the (x,y,z) position is on or near a tri-planar object, and the operation is:
if the cursor touches any of the planes:
while a defined mouse button is pressed, move the plane according to the cursor movement;
else if the cursor touches a face of the object's crop box:
while a defined mouse button is pressed, move the face of the crop box according to the cursor movement.

15. A 3D visualization system, comprising:
a data processor;
a memory in which software is loaded that facilitates the interactive visualization of 3D data sets in a virtual world, including a set of virtual tools, 3D display and processing functionalities;
a display; and
a 2D interface device;
wherein in operation the virtual tools and the operations on objects within the virtual world are controlled via user interaction with the 2D interface.

16. The system of claim 15 wherein the 2D interface is a mouse.

17. The system of claim 15, further comprising a keyboard, wherein in operation the virtual tools and the operations on objects within the virtual world are controlled via user interaction with the 2D interface device and the keyboard.

18. A computer program product comprising a computer usable medium having computer readable program code means embodied therein, the computer readable program code means in said computer program product comprising means for causing a computer to:
acquire a first (x,y) position from a 2D interface device;
transform said first position to a second (x,y) position in a plane within a 3D virtual world;
obtain a (x,y,z) position in the virtual world by projecting from a virtual eye through the second (x,y) position into the 3D virtual world to obtain a hit point;
position a cursor or other icon on the hit point.

19. A computer program product comprising a computer usable medium having computer readable program code means embodied therein, the computer readable program code means in said computer program product comprising means for causing a computer to:
receive user input selecting a 3D virtual tool;
obtain a first (x,y) position from a 2D device;
transform the first (x,y) position to a second (x,y) position in a plane within a 3D virtual world;
obtain a (x,y,z) position in the virtual world by projecting from a virtual eye through the second (x,y) position into the 3D virtual world until a 3D object is hit; and
operate on the object based upon the (x,y,z) position and the functionality of the virtual tool selected.
